(19) United States
(12) Patent Application Publication
(10) Pub. No.: US 2014/0261006 A1
(43) Pub. Date: Sep. 18, 2014

(54) TEMPERATURE-CONTROLLABLE GAS GRILL AND THE METHOD OF CONTROLLING GRILLING TEMPERATURE

(71) Applicant: GRAND MATE CO., LTD., Taichung (TW)

(72) Inventors: CHUNG-CHIN HUANG, Taichung (TW); CHIN-YING HUANG, Taichung (TW); HSIN-MING HUANG, Taichung (TW); HSING-HSIUNG HUANG, Taichung (TW); KUAN-CHOU LIN, Taichung (TW); YEN-JEN YEH, Yunlin (TW)

(73) Assignee: GRAND MATE CO., LTD., Taichung (TW)

(21) Appl. No.: 13/796,650

(22) Filed: Mar. 12, 2013

(51) Int. Cl. A47J 37/06; F24C 3/12

(52) U.S. Cl. CPC A47J 37/0682; F24C 3/124
USPC 99/333; 126/41 R; 431/12

(57) ABSTRACT

A temperature-controllable gas grill includes a main body having a grilling chamber, a plurality of burners in the main body to burn gas, a temperature sensor for sensing a current temperature in the grilling chamber, a gas valve, and a controller. The gas valve has a gate and a stepper motor, and the stepper motor moves the gate to change a gas flow supplied to the burners. The controller has a user interface and a processing unit. A user inputs a setting temperature through the user interface, and the processing unit controls the stepper motor according to the current temperature and the setting temperature to keep the current temperature in the grilling chamber in a limited range.

### BACKGROUND OF THE INVENTION

1. Technical Field

The present invention relates to a gas stove, and more particularly to a temperature-controllable gas grill and a method of controlling a grilling temperature of the gas grill.

2. Description of Related Art

BBQ is the commonest home activity, families and friends always enjoy the BBQ time. Gas grill is the most important equipment for BBQ to make fine foods for everyone in the party.

FIG. 1 shows a conventional gas grill 1, including a main body 10, a gas valve 16, a plurality of manual control valves 20, and a plurality of burners 22. The main body 10 has a base 11 and a cover 12. The cover 12 covers a top of the base 11 to form a grilling chamber 14 thereunder. Above the burners 22 is a rack 23, on which the foods are put. Gas from a gas pipe 18 is supplied to the burners 22 through the gas valve 16, and the manual control valves 20 are manipulative to control flames of the burners 22 respectively.

Temperature and time are two important factors to make fine foods with the gas grill. An inexperienced cook can't make fine food because he/she can't see the food under the cover 12. So, the cook sometime has to open the cover 12 to check the foods in the grilling chamber 14, and adjusts the control valves 20 accordingly. However, sometime the foods still are over burned because of lack of experience or negligence.

### BRIEF SUMMARY OF THE INVENTION

In view of the above, the primary objective of the present invention is to provide a temperature-controllable gas grill, which is able to control the temperature in the grill chamber.

The present invention provides a temperature-controllable gas grill, including a main body having a grilling chamber, at least one burner provided in the main body to burn gas, a temperature sensor for sensing a current temperature in the grilling chamber, at least one gas valve, and a controller. The gas valve has a gate and a stepper motor, and the stepper motor moves the gate to change a gas flow provided by the gas valve. The controller has a user interface and a processing unit. A user inputs a setting temperature through the user interface, and the processing unit controls the stepper motor according to the current temperature and the setting temperature to keep the current temperature in the grilling chamber in a limited range.

The present invention further provides a method to control a grilling temperature of a grilling chamber, including the following steps:

Inputting a setting temperature and obtaining a high limited temperature and a low limited temperature according to the setting temperature, wherein the high limited temperature is higher than the setting temperature, and the low limited temperature is lower than the setting temperature;

Sense a current temperature in the grilling chamber;

Compare the current temperature with the high limited temperature and the low limited temperature, and then

Control the stepper motor to supply the burner with a first gas flow when the current temperature is lower than the low limited temperature, or

Control the stepper motor to supply the burner with a second gas flow when the current temperature is higher than the high limited temperature; or

Control the stepper motor to supply the burner with a third gas flow when the current temperature is lower than the high limited temperature and is higher than the low limited temperature.

Wherein the third gas flow is greater than the second gas flow, and the first gas flow is greater than the third gas flow.

The gas grill of the present invention provides a temperature controllable function to provide a constant grilling temperature, so that even an inexperienced cook can make fine foods with the gas grill of the present invention.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1 is a block diagram of the conventional gas grill;

FIG. 2 is a block diagram of a first preferred embodiment of the present invention;

FIG. 3 is a sectional view of the gas valve of the first preferred embodiment of the present invention, showing the gas valve closed;

FIG. 4 is a sectional view of the gas valve of the first preferred embodiment of the present invention, showing the gas valve opened;

FIG. 5 is a flowchart of the preferred embodiment of the first present invention; and

FIG. 6 is a block diagram of a second preferred embodiment of the present invention.

### DETAILED DESCRIPTION OF THE INVENTION

FIG. 2 shows a gas grill 2 of the first preferred embodiment of the present invention, including a main body 24, a plurality of burners 32, a gas valve 34, a plurality of manual control valves 38, a temperature sensor, and a controller 42.

The main body 24 has a base 25 and a cover 28. The main base 25 is provided with a rack 26 on a top thereof to put foods thereon. The cover 28 covers the top of the base 24 to form a grilling chamber 30 thereunder. The burners 32 are received in the base 25 to burn gas.

As shown in FIG. 3 and FIG. 4, the gas valve 34 has a valve body 342, a gate 344, and a stepper motor 346. The valve body 342 is connected to a gas pipe 36, which supplies the burners 32 with gas. The valve body 342 has a gas passageway 342a, and the gate 344 is movably mounted in the gas passageway 342a. The stepper motor 346 is provided on the valve body 342. The stepper motor 346 has a shaft 346a, and the shaft 346a is connected to a block 346b. The block 346b is connected to the gate 344, therefore the stepper motor 346 is able to move the gate 344. The gate 344 is moved between an open position P1 (FIG. 3) and a close position P2 (FIG. 4). Because of the stepper motor 346, the gate 344 is able to move to any position between the first position P1 and the second position P2.

The manual control valves 38 are connected to each burner 32 respectively, and all the manual control valves 38 are connected to the gas valve 34 through the gas pipe 36. The manual control valves 38 are manipulative to adjust gas flows to the burners 32.

The temperature sensor is a thermalcouple 40 in the first preferred embodiment. The thermalcouple 40 is received in the grilling chamber 30 to sense a current temperature in the grilling chamber 30 and generate an electrical single accordingly.

The controller 42 is electrically connected to the thermalcouple 40 and the stepper motor 346 of the gas valve 34. The controller 42 receives the electrical signal from the thermalcouple 40 and generates a control signal accordingly to control the stepper motor 346. As a result, the gate 344 will be moved to a specified position between the first position P1 and the second position P2 to provide a specified gas flow to the manual control valves 38. The controller 42 has a user interface 44, a processing unit 45, and a memory 46. The user interface 44 is designed for a user to input a setting temperature and select a manual grilling mode or a constant-temperature grilling mode. The processing unit 45 controls the stepper motor 346 according to a difference between the setting temperature and the current temperature. The memory 46 is stored with several sets of temperature parameters and gas flow parameters. Each temperature parameter has a gas flow parameter correspondingly, and each gas flow parameter indicates a specific signal, which is sent to the stepper motor 346 to move the gate 344 to a specified position so as to control the gas valve 34 to provide a specified gas flow.

The cook grills foods without the cover 28 when he/she selects the manual grilling mode. In the manual grilling mode, the gas valve 34 always provides a constant gas flow, and the cook manually adjust each manual control valve 38 to change the flames of the burners 32.

When the cover 28 is put on the base 25, he/she may select the constant-temperature grilling mode and input a setting temperature through the user interface 44. The controller 42 will perform a method as shown in FIG. 5 to control a grilling temperature in the grilling chamber 30. The processing unit 45 of the controller 42 controls the stepper motor 34 according to the current temperature sensed by the thermalcouple 40 and the setting temperature to keep the grilling temperature in the grilling chamber 30 in a limited range.

After the user inputs a setting temperature, the processing unit 45 automatically generates a high limited temperature and a low limited temperature, wherein the high limited temperature is higher the setting temperature, and the low limited temperature is lower the setting temperature. The processing unit 45 compares the current temperature with the high limited temperature and the low limited temperature to control the stepper motor 346 accordingly.

While the current temperature is lower than the low limited temperature, the processing unit 45 controls the stepper motor 346 to let the gas valve 34 provide a first gas flow. With the first gas flow, the burners 32 heat up the grilling chamber 30. The first gas flow is stopped until the current temperature is higher than the low limited temperature.

When the current temperature is higher than the high limited temperature, the processing unit 45 controls the stepper motor 346 to let the gas valve 34 provide a second gas flow. The second gas flow is lower than the first gas flow to drop the temperature in the grilling chamber. The second gas flow is stopped until the current temperature is lower than the high limited temperature.

When the current temperature is higher than the low limited temperature and is lower than the high limited temperature, the processing unit 45 controls the stepper motor 346 to let the gas valve 34 provide a third gas flow. In an embodiment, the processing unit 45 compares the setting temperature with the temperature parameters to find the specified temperature parameter, which is identical to the setting temperature, and obtain the corresponding gas flow parameter. The processing unit 45 controls the stepper motor 346 according to the gas flow parameter to let the gas valve 34 provide the third gas flow. The third gas flow is higher than the second gas flow, but is lower than the first gas flow to keep the temperature in the grilling chamber 30 between the high limited temperature and the low limited temperature.

It is obvious that the burners 32 need a greater gas flow to keep the grilling chamber 30 in higher temperature. Therefore, the third gas flow is positive proportional to the setting temperature.

The gas grill 2 of the present invention provides two grilling modes for the user to grill foods with or without the cover 28. Even an inexperienced cook may grill fine foods with the gas grill 2 of the present invention. The electricity power for the stepper motor 34 will be cut off right after the gate 344 arrives at the predetermined position. Without the electricity power, the stepper motor 34 still can hold the gate 344. In other words, the electricity power is needed only when the gate 344 of the gas valve 34 is moving, therefore the gas grill 2 needs little electricity power for grilling foods.

An alternate way to control the temperature in the grilling chamber 30 is that the current temperature is compared with the setting temperature only rather than the high and low limited temperatures. The gas valve 34 is controlled to provide the first gas flow to the burner 32, which raises the temperature in the grilling chamber 30, when the current temperature is lower than the setting temperature and to provide the second gas flow to the burner 32, which drops the temperature in the grilling chamber 30, when the current temperature is higher than the setting temperature.

In an embodiment, the first gas flow is positive proportional to setting temperature as well to shorten the time for raising the temperature in the grilling chamber 30 to the setting temperature.

FIG. 6 shows a gas grill 3 of the second preferred embodiment of the present invention, which is similar to the first preferred embodiment, except that there are a plurality of gas valves 48 connected to each of the burners 32. Each gas valve 48 is provided with a stepper motor to control a gate therein. The gas valves 48 are the same as gas valve 34 of the first preferred embodiment. The gas grill 3 of the second preferred embodiment may individually control the burners 32.

In the constant-temperature grilling mode, the processing unit 44 controls the stepper motors of the control valves 48 to provide a specific gas flow (the first gas flow, the second gas flow, or the third gas flow) to the burners 32. The way of controlling the control valves 48 is the same as above, so we do not describe the detail again.

It must be pointed out that the embodiments described above are only some preferred embodiments of the present invention. All equivalent structures and manufacturing methods which employ the concepts disclosed in this specification and the appended claims should fall within the scope of the present invention.

What is claimed is:

1. A temperature-controllable gas grill, comprising:
a main body having a grilling chamber;
at least one burner provided in the main body to burn gas; and
at least one gas valve provided on a gas pipe, which supply the burner with gas, wherein the gas valve has a gate and a stepper motor, and the stepper motor moves the gate to change a gas flow provided by the gas valve;
a temperature sensor for sensing a current temperature in the grilling chamber; and
a controller, which is electrically connected to the temperature sensor and the stepper motor, having a user interface and a processing unit, wherein a user inputs a setting temperature through the user interface, and the processing unit controls the stepper motor according to the current temperature and the setting temperature to keep the current temperature in the grilling chamber in a limited range.

2. The temperature-controllable gas grill of claim 1, wherein the limited range has a high limited temperature and a low limited temperature; the high limited temperature is higher than the setting temperature, and the low limited temperature is lower than the setting temperature; the processing unit controls the stepper motor to let the gas valve provide a first gas flow when the current temperature is lower than the low limited temperature, and the processing unit controls the stepper motor to let the gas valve provide a second gas flow when the current temperature is higher than the high limited temperature, wherein the first gas flow is greater than the second gas flow.

3. The temperature-controllable gas grill of claim 2, wherein the first gas flow is positive proportional to the setting temperature.

4. The temperature-controllable gas grill of claim 2, wherein the processing unit controls the stepper motor to let the gas valve provide a third gas flow when the current temperature is lower than the high limited temperature and is higher than the low high limited temperature, wherein the third gas flow is lower than the first gas flow and is greater than the second gas flow.

5. The temperature-controllable gas grill of claim 4, wherein the controller further has a memory, in which a plurality of sets of temperature parameters and gas flow parameters are stored, the processing unit finds the temperature parameter, which is identical to the setting temperature, and the corresponding gas flow parameter in the memory when the current temperature is lower than the high limited temperature and is higher than the low high limited temperature, and then controls the stepper motor to let the gas valve provide the third gas flow according to the gas flow parameter.

6. The temperature-controllable gas grill of claim 4, wherein the third gas flow is positive proportional to the setting temperature.

7. The temperature-controllable gas grill of claim 1, wherein a number of the at least one burner is two or more, and a number of the at least one gas valve is identical to the burners; the gas valves are connected to the burners respectively; and the processing unit is connected to all of the stepper motors of the gas valves.

8. A method of controlling a grilling temperature of a gas grill, wherein the gas grill includes a main body having a grilling chamber, a burner in the main body to burn gas, a gas valve on a gas pipe to supply the burner with gas, and a controller; the gas valve has a stepper motor, which is controllable to change a gas flow provided by the gas valve, the method comprising the steps of:
inputting a setting temperature and obtaining a high limited temperature and a low limited temperature according to the setting temperature, wherein the high limited temperature is higher than the setting temperature, and the low limited temperature is lower than the setting temperature;
sensing a current temperature in the grilling chamber;
comparing the current temperature with the high limited temperature and the low limited temperature, and then
controlling the stepper motor to supply the burner with a first gas flow when the current temperature is lower than the low limited temperature, or
controlling the stepper motor to supply the burner with a second gas flow when the current temperature is higher than the high limited temperature; or
controlling the stepper motor to supply the burner with a third gas flow when the current temperature is lower than the high limited temperature and is higher than the low limited temperature;
wherein the third gas flow is greater than the second gas flow, and the first gas flow is greater than the third gas flow.

9. The method of claim 8, further comprising the steps of:
comparing the setting temperature with a plurality of temperature parameters when the current temperature is lower than the high limited temperature and is higher than the low limited temperature, wherein each of the temperature parameters has a gas flow parameter correspondingly; and
obtaining the temperature parameter, which is identical to the setting parameter, and the corresponding gas flow parameter;
controlling the stepper motor according to the gas flow parameter to supply the burner with the third gas flow.

10. The method of claim 8, wherein the first gas flow is positive proportional to the setting temperature.

11. The method of claim 8, wherein the third gas flow is positive proportional to the setting temperature.
